(19) United States
(12) Patent Application Publication
(10) Pub. No.: US 2018/0120412 A1
(43) Pub. Date: May 3, 2018

(54) System and Method of Passively Tracking Moving Object Within Structure

(71) Applicant: Kwangwoon University Industry-Academic Collaboration Foundation, Seoul (KR)

(72) Inventor: Youngok Kim, Namyangju-si (KR)

(73) Assignee: Kwangwoon University Industry-Academic Collaboration Foundation, Seoul (KR)

(21) Appl. No.: 15/358,562

(22) Filed: Nov. 22, 2016

(30) Foreign Application Priority Data
Oct. 31, 2016 (KR) 10-2016-0143376

(51) Int. Cl. G01S 5/02; H04W 4/04; H04B 17/318

(52) U.S. Cl. CPC G01S 5/0294; H04W 4/04; H04W 84/18; G01S 5/0226; G01S 5/0221; H04B 17/318

(57) ABSTRACT

Disclosed is system and method of passively tracking a moving object inside a structure. The method includes: forming a LOSL by a plurality of transmitting modules and a plurality of receiving modules; gathering, by the receiving modules, values changed in received signal strengths (RSS) and transmitting the gathered values to the controller by the plurality of receiving modules, the RSS values being changed when the LOSL is blocked by a movement of the moving object; recording, by the controller, sequences and time stamps of the blocked LOSL by receiving the changed RSS values from the receiving modules; estimating, by the controller, a cross point at which the moving object crosses the LOSL based on the recorded sequences and time stamps of the blocked LOSL; and tracking, by the controller, a moving path of the moving object based on information of the estimated cross point.

### STATEMENT OF GOVERNMENTAL SUPPORT

This invention was made with government support under Project No. NRF-2016R1D1A1B03932980 awarded by the Ministry of Education, National Research Foundation of Korea (NRF) which is in the business of supporting individual researchers for Science and Engineering. The government support was for the subject, “Wireless Web Based Passive Tracking and Hybrid Tracking Technology Method,” at a contribution rate of 1/1 for the research period of Nov. 1, 2016 through Oct. 31, 2019. The supervising institute was also the National Research Foundation of Korea (NRF).

### BACKGROUND OF THE INVENTION

### Field of the Invention

The present invention relates generally to system and method of passively tracking a moving object inside a structure. More particularly, the present invention relates to system and method of passively tracking a moving object inside a structure, whereby an accuracy of a tracking position of the moving object can be improved without requiring the moving object to carry a terminal or a sensor, by measuring values changed in received signal strengths (RSS), the RSS values being changed when a line of sight link (LOSL) is blocked by a movement of the moving object, and applying a particle swarm optimization (PSO) algorithm to the measured RSS values.

### Description of the Related Art

Recently, the field of indoor tracking using widespread diffusion of wireless LAN access points and intelligent mobile terminals is an emerging field. The indoor tracking field also uses received signal strengths (RSS) technique. According to tracking technique field, the indoor tracking method can be classified in two categories: an active tracking method and a passive tracking method. In the active tracking method, a target is required to carry an auxiliary device such as smartphone, laptop, etc. to transmit a RSS value that is used for estimating a position of the target. However, in such a tracking method, the target cannot be expected to carry the auxiliary device. For example, an intruder tends not to carry a wireless terminal that can communicate with a monitoring system, or the wireless terminal of the intruder is not capable of providing an RSS value that may be used for tracking him or her. In addition, it may be impossible for a kidnapped person or a child to carry a wireless terminal. The passive tracking method refers to a method of tracking a target that is not carrying an auxiliary device. Radio frequency tomography is an emerging technique in the field of indoor tracking of an object not carrying an auxiliary device. Radio frequency tomography refers to a technique that may be related to the variation of a radio signal changed by a target while the target crosses a line of sight link (LOSL) formed between a plurality of pair nodes. In other words, radio frequency tomography detects a variation of a RSS value. Radio frequency tomography is powerful and easily obtains measurements in an extreme environmental conditions compared with a distance measuring technique or a conventional RSS related field such as fingerprint recognition technique. However, the conventional method is problematic in that the method requires a specific node with high density forming a network to assure tracking accuracy can be trusted. Satisfying the requirement is complicated, and thus feasibility is reduced.

Meanwhile, Korean Patent Application Publication No. 10-2010-0137821 (Patent document 1) discloses system and method of tracking a moving object inside a structure, whereby positions of a plurality of moving objects within a closed area such as building, basement and tunnel, etc. are tracked. The system includes a plurality of portable transmitting devices provided to the plurality of moving objects, and a receiving device installed outside the closed area, receives data from the transmitting devices, and transmits the received data to a position checking server to track current positions of the moving objects. The method includes: (a) setting, by the transmitting devices, unique distinguished IDs assigned to the transmitting devices such that the transmitting devices are distinguished from each other before starting to track positions and setting transmitting periods and intensity levels of radio signals; (b) detecting, by the transmitting devices, heights of the moving object when the transmitting devices being operated to track the positions, generating radio signals with the intensity levels by synchronizing with the detected times, and transmitting the detected heights and detected time information to the receiving device; (c) after completing the measurement, checking, by the receiving device, received time information of the received radio signals and measuring intensity levels thereof; (d) transmitting, by the receiving device, data transmitted from the transmitting devices, received time information, and the measured intensity levels of the radio signals to the position checking server; (e) storing, by the position checking server, the data transmitted from the receiving device, and detecting three-dimensional vertical positions of the moving objects based on the unique distinguished IDs and the heights thereof; and (f) simultaneously detecting, by the position checking server, respective horizontal positions of the moving objects by using one or more of the intensity level of each unique distinguished ID or a time variation between the transmitting time information and received time information of the unique distinguished ID.

The above patent document 1 is able to detect a three-dimensional position of a moving object by tracking two-dimensional horizontal and vertical distances. However, the moving object has to carry the portable transmitting device, thus it impossible to track a position of a moving object inside a structure when the object is not carrying the transmitting device.

The foregoing is intended merely to aid in the understanding of the background of the present invention, and is not intended to mean that the present invention falls within the purview of the related art that is already known to those skilled in the art.

### DOCUMENT OF RELATED ART

### Patent Document

(Patent document 1) Korean Patent Application Publication No. 10-2010-0137821

### SUMMARY OF THE INVENTION

Accordingly, the present invention has been made keeping in mind the above problems occurring in the related art, and the present invention is intended to propose system and method of passively tracking a moving object inside a structure, whereby the accuracy of a position tracking (detecting) of the moving object can be improved without requiring the moving object to carry a terminal or a sensor, by using a geometric formulation technique configured with a plurality of access points APs and wireless terminals WTs, measuring values changed in received signal strengths (RSS), the RSS values being changed when a line of sight link (LOSL) is blocked by a movement of the moving object, and applying a particle swarm optimization (PSO) algorithm to the measured RSS values.

In order to achieve the above object, according to one aspect of the present invention, there is provided a system for passively tracking a device-free moving object inside a structure, the system including: a plurality of transmitting modules installed on a surface of an inner sidewall of a structure and forming a line of sight link (LOSL) by transmitting radio signals for detecting a moving object; a plurality of receiving modules installed on a surface of a wall that faces the wall on which the plurality of transmitting modules are installed, forming the LOSL with the transmitting modules by receiving the radio signals transmitted from the transmitting modules, and gathering values changed in received signal strengths (RSS) of the radio signals, and transmitting the gathered values to an upper layer, the RSS values being changed when the LOSL is blocked by a movement of the moving object; and a controller electrically connected both to the plurality of transmitting modules and to the plurality of the receiving modules, checking states of the transmitting modules and the receiving modules and controlling operations of the transmitting modules and the receiving module, recording sequences and time stamps of the blocked LOSL by receiving the changed RSS values from the receiving modules, and tracking a moving path of the moving object by using cross point information based on the recorded sequences and time stamps in which the moving object crosses the LOSL.

Herein, preferably, the controller may include a software program configured to execute a particle swarm optimization (PSO) algorithm that uses previous historical information of the moving object to detect an accurate position of a current cross point between the LOSL and the moving object.

Herein, the previous historical information of the moving object may include at least cross point information and a time stamp of an immediately preceding LOSL(LOSL(n−1)) cross point between the LOSL and the moving object.

In addition, the transmitting modules and the receiving modules may be fixed at predetermined locations.

In addition, the transmitting modules and the receiving modules may be asymmetrically disposed with each other such that the moving path of the moving object does not become absolutely symmetrical.

In addition, the transmitting modules may be wireless routers and the receiving modules are smart phones.

In addition, the receiving modules may be positioned to be spaced apart from the wall by predetermined distances to relieve a multi-path effect of the radio signals while gathering the changed RSS values.

In another aspect of the present invention, there is provided, a method of passively tracking a device-free moving object inside a structure by using a passive tracking system, the system including a plurality of transmitting modules, a plurality of receiving modules, and a controller, the method including: a) forming, by the plurality of transmitting modules, a line of sight link (LOSL) by transmitting radio signals for detecting the moving object; b) forming, by the plurality of receiving modules, the line of sight link (LOSL) with the plurality of transmitting modules by receiving the radio signals transmitted from the plurality of transmitting modules; c) gathering values changed in received signal strengths (RSS) and transmitting the gathered values to the controller from the plurality of receiving modules, the RSS values being changed when the LOSL is blocked by a movement of the moving object; d) recording, by the controller, sequences and time stamps of the blocked LOSL by receiving the changed RSS values from the receiving modules; e) estimating, by the controller, a cross point at which the moving object crosses the LOSL based on the recorded sequences and time stamps of the blocked LOSL; and f) tracking, by the controller, a moving path of the moving object based on information of the estimated cross point.

Herein, in the estimating the cross point, the controller may execute a particle swarm optimization (PSO) algorithm that uses previous historical information of the moving object to estimate an accurate position of a current cross point between the LOSL and the moving object by executing a software program provided therein.

Herein, the previous historical information of the moving object may include at least cross point information and a time stamp of a just previous LOSL(LOSL(n−1)) cross point between the LOSL and the moving object.

In addition, the PSO algorithm may include: i) uniformly scattering particles having two elements within θ, within a limited area that is expressed in formula 1; ii) calculating a suitable value for each particle by using formula 5 and initially setting a best suited position P_{best} among the calculated suited values to self-historical information; iii) initially setting a particle that has the best suited value among all particles to a best suited position of the all gathered values;

iv) calculating a particle speed for each particle by using formula 7 and updating a particle position by using formula 8; v) calculating a suitable value for each particle by using the formula 5, and updating to the P_{best} if a current P_{best} is better than the P_{best} of the historical information, wherein the formula; and vi) updating to a G_{best} if a current G_{best} is better than a G_{best} of the historical information before reaching the maximum number of iteration times.

Herein, in the updating of the particle position, the update may be canceled when an updated position exceeds the limited area.

According to the present invention, an accuracy of tracking (detecting) of an object moving inside a structure is improved by measuring values changed in received signal strengths (RSS) according to the passage of the moving object through an LOSL and applying a particle swarm optimization algorithm to the measured RSS values.

### BRIEF DESCRIPTION OF THE DRAWINGS

The application file contains at least one drawing executed in color. Copies of this patent application publication with color drawings will be provided by the Office upon request and payment of the necessary fee.

The above and other objects, features and other advantages of the present invention will be more clearly understood from the following detailed description when taken in conjunction with the accompanying drawings, in which:

FIG. 1 is a schematic view showing a system configuration for passively tracking a moving object inside a structure according to an embodiment of the present invention;

FIG. 2 is a flowchart showing a method of passively tracking a moving object inside a structure according to an embodiment of the present invention;

FIGS. 3A to 3C are views respectively showing an exemplary summary, a reduction of a received signal strength, and a relation between distance of transmitting/receiving module and a feature of reduced RSS that are related with a radiofrequency (RF) tomography irradiation applied to the present invention;

FIG. 4 is a view showing an example of estimating a cross point CP within LOSL by using a conventional method in a method of passively tracking a moving object inside a structure according to the present invention;

FIG. 5 is a view showing a convergence process of a particle swarm optimization (PSO) for estimating a cross point CP by using an estimation method based on geometric formulation GF;

FIG. 6 is a view showing results of cross point estimations by using various methods; and

FIG. 7 is a view showing a performance comparison of cross point CP estimations by using various techniques.

### DETAILED DESCRIPTION OF THE INVENTION

Terms or words used in the specification and claims are not limited to meaning that is commonly understood by people or is defined in dictionaries, and should be interpreted as having a meaning that is consistent with meaning in the context of the relevant art.

Unless the context clearly indicates otherwise, it will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. Also, the terms “˜part”, “˜unit”, “module”, “apparatus” and the like mean a unit for processing at least one function or operation and may be implemented by a combination of hardware and/or software.

Herein below, exemplary embodiments of the present invention will be described in detail with reference to the accompanying drawings.

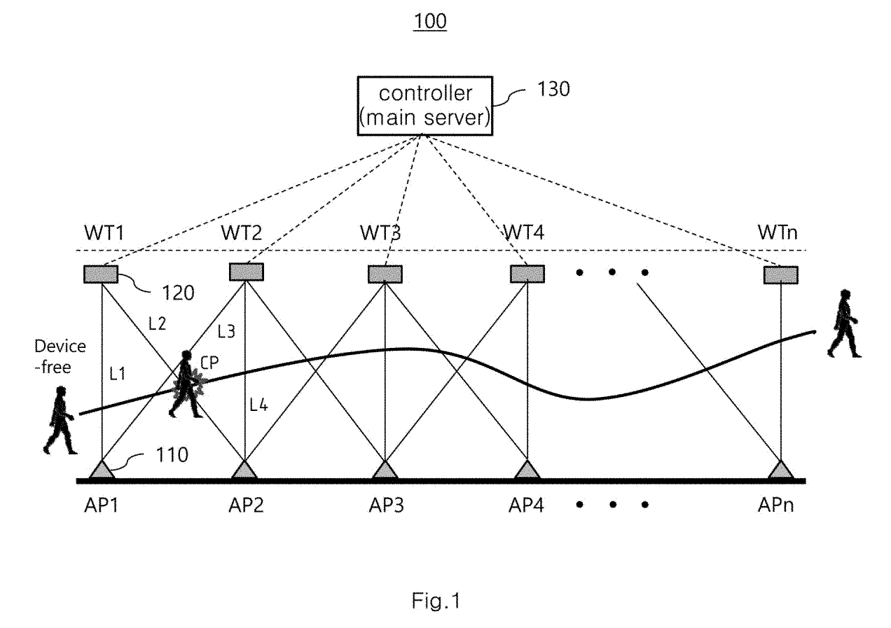

FIG. 1 is a schematic view showing a system configuration for passively tracking a moving object inside a structure according to an embodiment of the present invention.

Referring to FIG. 1, a system for passively tracking a device-free moving object inside a structure 100 according to the present invention includes a transmitting module 110, a receiving module 120, and a controller 130.

The transmitting module 110 is installed on a surface of an inner sidewall of a structure, and forms a line of sight link (LOSL) (a kind of a mesh of radio signals shown in FIG. 1 as L1 to L4) by transmitting a radio signal for detecting the moving object. The transmitting module 110 corresponds to an access point AP and is provided in plural on the surface of the sidewall. Herein, the plurality of transmitting modules 110 may be installed on the surface of the inner sidewall and placed alongside each other in a horizontal direction with identical heights from a ground surface, or may be installed in an upwardly inclined form in which heights of the plurality of transmitting modules 110 gradually becomes higher, or may be installed in a downwardly inclined form in which heights of the plurality of transmitting modules 110 gradually becomes lower, or may be installed to be randomly (irregularly) placed without any limitation on a specific height. In addition, the transmitting modules 110 may be fixed at predetermined positions. In other words, the transmitting modules 110 may be fixed at positions whereby coordinates of the positions thereof are identified. In addition, a wireless router may be used as the transmitting module 110.

The receiving module 120 is installed on a surface of a wall that faces the sidewall on which the transmitting modules 110 are installed, forms the LOSL with the transmitting modules 110 by receiving the radio signals transmitted from the transmitting module 110, gathers values changed in received signal strengths (RSS) of the radio signals, and transmits the gathered values to an upper layer, in other word, to the controller 130, whereby the RSS values are changed when the LOSL is blocked by a movement of the moving object. The receiving module 120 corresponds to a wireless terminal WT and is provided in plural on the surface of the wall as like the transmitting modules 110. In addition, the receiving modules 120 may be installed in various forms as like the transmitting modules 10. Herein, the receiving modules 120 may be positioned to be spaced apart from the wall by predetermined distances (for example, 2 m) to relieve a multi-path effect of the radio signals while gathering the changed RSS values. In addition, the receiving modules 120 may be installed in predetermined positions as like the transmitting modules 120. In other words, the receiving modules 120 may be fixed on positions whereby coordinates of the positions thereof are identified. In addition, a smart phone may be used as the receiving module 110.

Further, preferably, the transmitting modules 110 and the receiving modules 120 are asymmetrically disposed with each other such that a moving path of the moving object does not become absolutely symmetrical.

The controller 130 is electrically connected both to the plurality of transmitting modules 110 and the plurality of receiving modules 120, checks states of the transmitting modules 110 and the receiving modules 120 and controls operations of the transmitting modules 110 and the receiving modules 120, records sequences and time stamps of the blocked LOSL by receiving the changed RSS values from the receiving modules 120, and tracks a moving path of the moving object by using cross point CP information based on the recorded sequences and time stamps in which the moving object crosses the LOSL. The controller 130 functions as a main server. A desktop, a laptop, according to circumstances, a microcontroller, etc. may be used as the controller 130.

Herein, preferably, in order to accurately track a current position of the cross point between the LOSL and the moving object, the controller 130 includes a software program configured to execute a particle swarm optimization (PSO) algorithm that uses previous historical information of the moving object. Herein, the previous historical information of the moving object may include at least cross point information and a time stamp of an immediately preceding LOSL(LOSL(n−1)) (for example, L1) cross point between the LOSL and the moving object. The current cross point CP may be, for example, a cross point CP of L2 in FIG. 1.

Now, a method of passively tracking a moving object inside a structure using the system for passively tracking the moving object according to the present invention is briefly described.

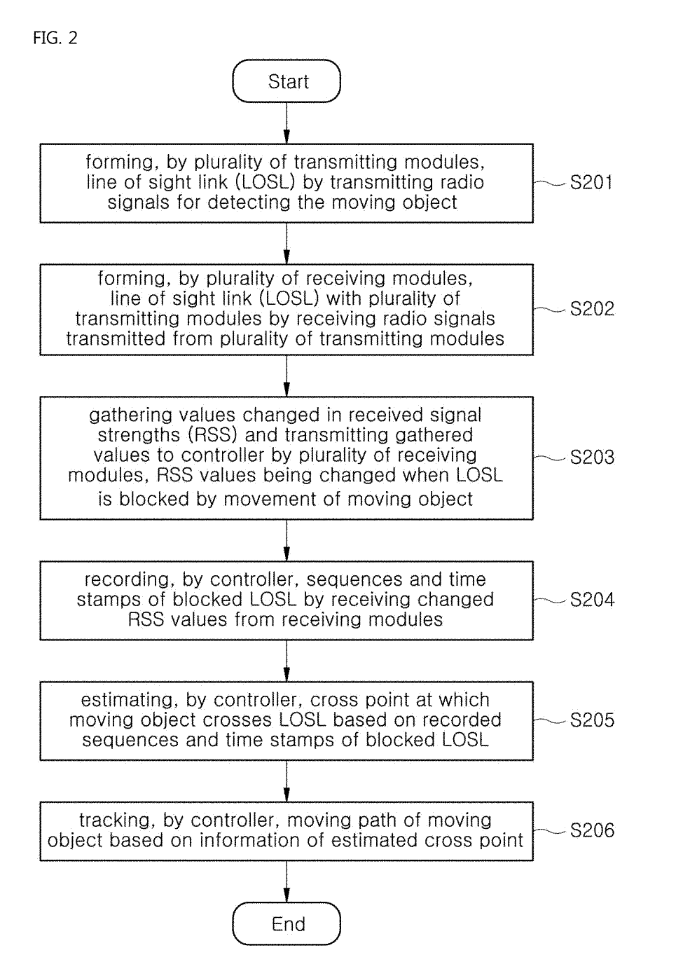

FIG. 2 is a flowchart showing a method of passively tracking a moving object inside a structure according to an embodiment of the present invention.

Referring to FIGS. 1 and 2, the method of passively tracking the moving object inside a structure according to the present invention is based on the system for passively tracking the moving object within the structure 100, including a plurality of transmitting modules 110, a plurality of receiving modules 120, and a controller 130, as described above, and the method tracks a device-free moving object. First, the plurality of transmitting modules 110 forms a line of sight link (LOSL) by transmitting radio signals for detecting the moving object (S201).

Also, the plurality of receiving modules 120 forms the line of sight link (LOSL) with the plurality of transmitting modules 110 by receiving the radio signals transmitted from the plurality of transmitting modules 120 (S202).

As described above, when the LOSL (a kind of a mesh of radio signals) is formed by the plurality of transmitting modules 110 and receiving modules 120, the receiving modules 120 gathers values changed in received signal strengths (RSS) and transmit the gathered values to the controller 130, the RSS values are changed when the LOSL is blocked by a movement of the moving object (S203).

Then, the controller 130 records sequences and time stamps of the blocked LOSL by receiving the changed RSS values from the receiving modules 120 (S204), estimates a cross point CP in which the moving object crosses the LOSL based on the recorded sequences and time stamps of the blocked LOSL (S205). Herein, the controller 130 may execute a particle swarm optimization (PSO) algorithm that uses previous historical information of the moving object to accurately estimate a current position of the cross point CP between the LOSL and the moving object by executing a software program provided therein. Herein, the previous historical information of the moving object may include at least cross point information and a time stamp of an immediately preceding LOSL(LOSL(n−1)) cross point CP between the LOSL and the moving object.

Thus, the controller 130 tracks a moving path of the moving object based on information of the estimated cross point CP (S206) after estimating the cross point CP in which the moving object crosses the LOSL.

Herein the PSO algorithm is configured to include: i) uniformly scattering particles having two elements within θ(θ=[y_{cp}ⁱ,\hat{k}ⁱ]), within a limited area that is mentioned in formula 1 (described later); ii) calculating a suitable value for each particle by using formula 5 (described later) and initially setting a best suited position P_{best} among the calculated suitable values to self-historical information; iii) initially setting a particle that has the best suited value among all particles to a best suited position of the all gathered values; iv) calculating a particle speed for each particle by using formula 7 (described later) and updating a particle position by using formula 8 (described later); v) calculating a suitable value for each particle by using the formula 5 (described later), and updating to the P_{best} if a current P_{best} is better than the P_{best} of the historical information; and vi) updating to a G_{best} if a current G_{best} is better than a G_{best} of the historical information before reaching the maximum number of iteration times. Herein, when updating the particle position, the update may be canceled when an updated position exceeds the limited area.

Hereinafter, additional explanation for the system and method of passively tracking the moving object inside the structure according to the present invention will be described.

In the present invention, it is assumed that the plurality of transmitting modules 110 (access point AP) and receiving modules 120 (wireless terminal WT) are fixed on predetermined positions. Positional information of the receiving modules 120 is obtained in advance by using an active position tracking technique.

As a preliminary process of the present invention, the inventor has studied a feature of radio frequency (RF) tomography when a person (moving object) passes through the LOSL formed by the transmitting modules 110 (access point) and the receiving modules 120 (wireless terminal). When the person walks into a mesh of the LOSL, according to sequences and time stamps of the blocked LOSL, an estimation process of cross points CP within the LOSL, in other words, an estimation of tracking a target, may be expressed as a basic geometric optimization equation. The geometric optimization equation may be solved by applying a particle swarm optimization (PSO) algorithm. Herein, the radio frequency (RF) tomography that is applied to the present invention will be described.

<RF Tomography>

Features of radio frequency (RF) tomography that is used as a basic knowledge for passively tracking positions have been studied. For this, a relation between distances from cross points CP within the LOSL to the receiving modules 120 (WT) and features of momentary reductions of received signal strengths (RSS) caused by walking of the person (moving object) is described.

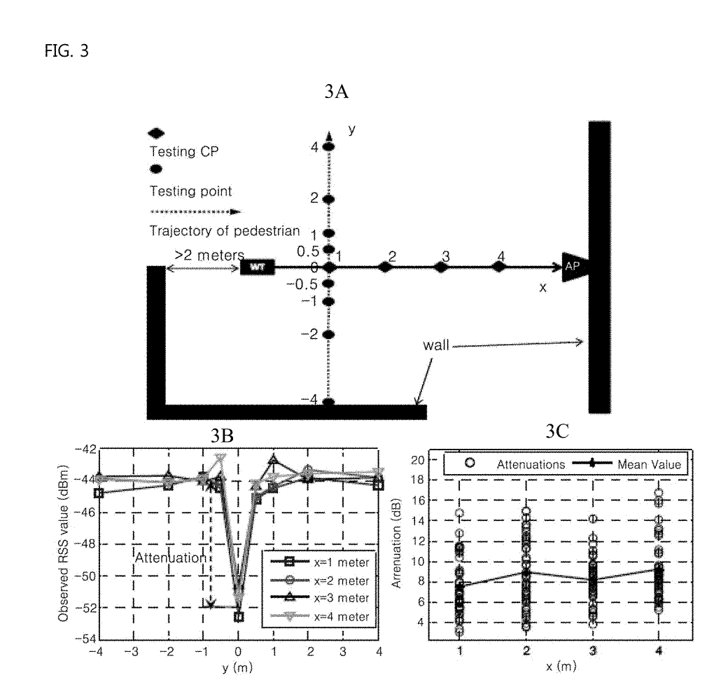

FIG. 3A shows a sketch (summary) of an experiment. It is assumed that the access point AP (transmitting module 110 in the present invention) is attached on a surface of a wall and the wireless terminal WT with identified positional information (receiving module 120 in the present invention) is placed in an arbitrary position. The person (moving object) passes through the LOSL via plurality of cross points CP that are positioned to have different distances from the wireless terminal WT. The wireless terminal WT (receiving modules 120) is positioned to be spaced apart from the wall by 2 m to relieve a multi-path effect of the radio signals while gathering RSS values.

In the experiment, four cross points (diamond point in FIG. 3A) are set within the LOSL, and the cross points are respectively spaced apart from the wireless terminal WT by x=1 m, 2 m, 3 m, and 4 m. When a target (moving object) walks along a track that is dotted in vertical direction in the figure via the cross points, the wireless terminal WT gathers each of the five RSS samples on a y-axis in every testing points (rounded dots). Results of the experiment shown in FIG. 3B show that about an 8 dB of a RSS reduction clearly appears when an obstacle is closer to the LOSL less than 0.5 m. The present inventor has defined the above phenomenon as meaning that the LOSL is blocked (interfered). After performing hundreds of experiments of passing through cross points different from each other within the LOSL, measured reduced RSS values are shown in FIG. 3C. FIG. 3C shows that an average of the reduced RSS values of the four crossing points is non-monotonic and about 9 dB. This result shows that it is difficult to conclude the experiment since a relation between an x value and the reduced RSS value is irregular.

<System Explanation and Geometric Formulation>

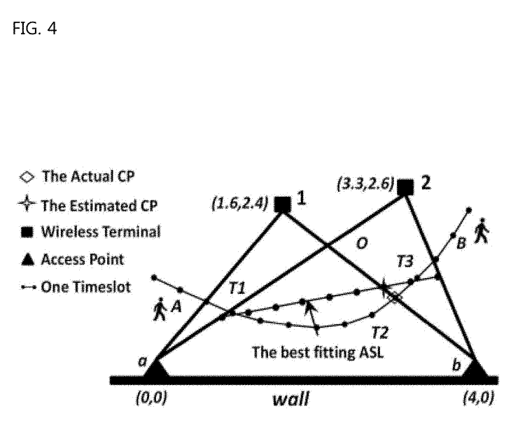

FIG. 4 shows a wireless LAN (WLAN) configuration in which two wireless terminals WTs are fixed on a surface of a wall and two access points APs are randomly disposed. A target (refer to a person) continuously walks along a path including curves. While performing a position tracking method of the present invention, sequences and time stamps of blocked (interfered) LOSL are recorded by measuring values thereof. An ith blocked LOSL is recorded as L(i)(i=1, 2, . . . , K), and an elapsed time between blocked L(i) and L(i+1) is recorded as t(i). A track of the target is estimated by finding a cross point Pᵢ within the L(i). For example, as shown in FIG. 4, the target moves from A to B along a track AB, and a system gathers sequences of the blocked LOSL that are L(i)(i=1,2,3,4). Herein, the sequences L(i) of the blocked LOSL are L1a, L2a, L1b, L2b, respectively, and related elapsed times are T(1)=1, T(2)=6, T(3)=2. Herein, L1 refers to a track between a wireless terminal WT1 and an access point APa. When the LOSL is blocked, a cross point CP within the LOSL is determined to track the target. However, as the above description of RF tomography, it is impossible to determine how long the cross point CP is spaced apart from the wireless terminal WT by using only the reduced RSS value. Therefore, the present invention provides two techniques to determine the cross point CP.

1) A Conventional Method (CM) for Estimating a Cross Point CP

Generally, when L(i) is blocked, a midpoint within the L(i) is selected as ith cross point CP, Pᵢ(x_{cp}ⁱ, y_{cp}ⁱ) to minimize a (position) tracking error. However, when a sequence of the blocked L(i) is considered, the cross point CP is set to a midpoint of a segment that is limited within the LOSL, the segment is cut off by a previous blocked LOSL and a succeeding blocked LOSL. The segment may be expressed as formula 1.

x_{cp}ⁱ,y_{cp}ⁱ∈[L(i)∩L(i−1)˜L(i)∩L(i+1)] [Formula 1]

For example, as shown in FIG. 4, since L(2) is L2a and L(4) is L2b, P3 (in other words, Lib) within L(3) does not seem to place on segment O1. Thus, P(3) is set to a midpoint of a segment cut off by L(2) and L(4), and the present invention defines the above method as a conventional method for estimating a cross point CP.

2) Geometric Formulation for Estimating a Cross Point CP

In addition to the sequences of the blocked LOSL, an elapsed time T(i) that is similar to a geometric formulation GF technique is used for accurately estimating the cress point CP. In FIG. 4, an estimation process of P3 within L(3) is selected as an example for estimating a cross point CP based on the geometric formulation. Elapsed times T(2) and T(3) are assigned as time slots 6 and 2, respectively. In the present invention, a track passing through neighboring segments in a straight line that is called as an approximate straight line (ASL), is calculated in an approximate value. Actually, an ASL that matches best to T(2) and T(3) will be a solution of an inclination and the cross point CP within L(3). In other words, the present invention tries to find a suitable ASL in which two segments that are cut off by neighboring three LOSL, for example L(2), L(3) and L(4), matches best to T(2) and T(3). Herein, a cross point between the best suited ASL and L(3) is estimated to be the P3 within L(3). By the same estimation, P2 within L(2) that includes information of T(1), T(2) and blocked LOSL may be found. Therefore, an equation to find a cross point CP is formulized as a geometric model that tries to find a suited ASL, and the cross point CP is estimated to be a cross point between the best suitable ASL and corresponding LOSL. The above formulation is defined as a geometric formulation.

First, Pᵢ is positioned within L(i), this may be expressed as formula 2 in a slope-segment form.

y_{cp}ⁱ=kⁱ·x_{cp}ⁱ+bᵢ [Formula 2]

Wherein, kⁱ and bⁱ are a slope of L(i) and y-segment, respectively, and the kⁱ and bⁱ are known in advance according to coordinates of cross points APs and wireless terminals WTs of third persons.

In the present invention, the track of the target between T(i−1) and T(i) is calculated in an approximated value by using an ASL. Meanwhile, since the ASL is Pᵢ that passes through, the ASL may be expressed as formula 3 in a point-slope form.

y−y_{cp}ⁱ=\hat{k}ⁱ·(x−x_{cp}ⁱ) [Formula 3]

Wherein, \hat{k}ⁱ is a slope of the ASL to be estimated.

Formula 4 is obtained by substituting the formula 2 to the formula 3.

y=\hat{k}ⁱ·x+[(kⁱ−\hat{k}ⁱ)·y_{cp}ⁱ+\hat{k}ⁱ·bⁱ]/kⁱ [Formula 4]

In the formula 4, θ=[y_{cp}ⁱ, \hat{k}ⁱ] are two unknown contentious issues to determine the ASL. The ASL crosses with L(i−1) and L(i+1), and cross points of L(i−1) and L(i+1) are defined as y=kⁱ⁻¹·x+bⁱ⁻¹, y=kⁱ⁺¹·x+bⁱ⁺¹, respectively. In the present invention, distances from Pᵢ to the two cross points are defined as theory distances dₜₕⁱ and dₜₕⁱ⁺¹. In other words, dₜₕⁱ and dₜₕⁱ⁺¹ refer to respective segment lengths within ASL that are cut off by L(i) and L(i+1). Since the target walks with a specific velocity v/s, distances from L(i−1) to L(i) and from i−1) to L(i) may be obtained by dₘⁱ=T(i−1)*ν/s,dₘⁱ⁺¹=T(i)*ν/s. In the present invention, a formulation of the target is to minimize a means square error between theory distances and measured distances. In other words, it is to maximize a non-linear function of the formula 5.

fun=1/Σⱼ₌₁ⁱ⁺¹(dₜₕ^{j}−dₘ^{j})² [Formula 5]

dₜₕⁱ and dₜₕⁱ⁺¹ are depended on the formula 4 of the ASL having two contentious issues. Thus, the formula 5 may be expressed as formula 6.

$${max}_{{y}_{cp}^{i} , {\hat{k}}^{i}} fun ( {y}_{cp}^{i} , {\hat{k}}^{i} \vert T ( i ) , L ( i ) , {k}^{i} , {b}^{i} , i = 1 , … K ) \qquad [ Formula 6 ]$$

The formula 6 is controlled by a segment expressed in the formula 1. Estimations of the first and the last cross points P₁ and P_{K} are not considered in the present invention. Because, T(0) and T(K) do not exist.

A particle swarm optimization (PSO) algorithm that is related with evolutionary computation is a well known and effective tool to optimize a non-linear multi-argument function. A solution of an optimization equation of the formula 6 having two elements within the θ is expressed as “Algorithm 1”. For example, \hat{k}ⁱ is selected as a certain particle, a seek velocity v of the particle is updated according to formula 7.

ν(t+1)=w·ν(t)+c₁·rand( )·(P_{best,\hat{k}}_{ⁱ}(t)−\hat{k}ⁱ(t))+c₂·rand( )·(G_{best,\hat{k}}_{ⁱ}(t)−\hat{k}ⁱ(t)) [Formula 7]

Then, the seek velocity is assigned to \hat{k}ⁱ as formula 8.

\hat{k}ⁱ(t+1)=\hat{k}ⁱ(t)+ν(t+1) [Formula 8]

In the formulas 7 and 8, t refers to a number of iterative step, w∈(0.1, 0.5) is an inertia weight, C₁ and C₂ are velocity constants and are 1.096, rand 0 is a random value between 0 and 1, and P_{best,\hat{k}}_{ⁱ}(t) and G_{best,\hat{k}}_{ⁱ}(t) are the best suited position within \hat{k}ⁱ and the overall best suited position of the iteration t of the particle.

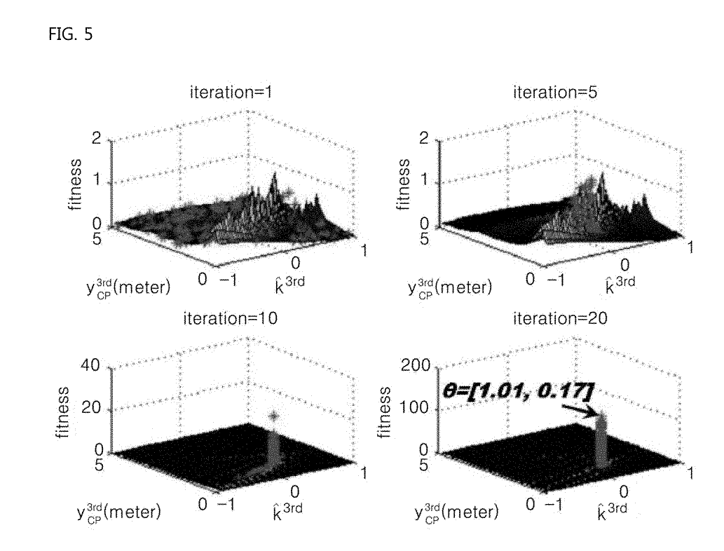

FIG. 5 is a view showing a convergence process of estimating P3 in case of 300 populations of particle.

As shown in FIG. 5, a PSO algorithm may complete a convergence process within 20 iterations, and this can sufficiently save the computation cost.

<Algorithm 1 (PSO Algorithm Based on GF for Estimating a Cross Point)>

The algorithm 1 is configured to include:

i) uniformly scattering particles having two elements within θ, within a limited area that is mentioned in formula 1 (described later);

ii) calculating a suitable value for each particle by using formula 5 (described later) and initially setting a best suited position P_{best} among the calculated suited values to a historical information;

iii) initially setting a particle that has the best suited value among all particles to a best suited position of the all gathered values;

iv) calculating a particle speed for each particle by using formula 7 (described later) and updating a particle position by using formula 8 (described later);

v) calculating a suitable value for each particle by using the formula 5 (described later), and updating to the P_{best} if a current P_{best} is better than the P_{best} of the historical information; and

vi) updating to a G_{best} if a current G_{best} is better than a G_{best} of the historical information before reaching the maximum number of iteration times

Herein, when updating the particle position, the update is canceled when an updated position exceeds the limited area.

<Performance Evaluation>

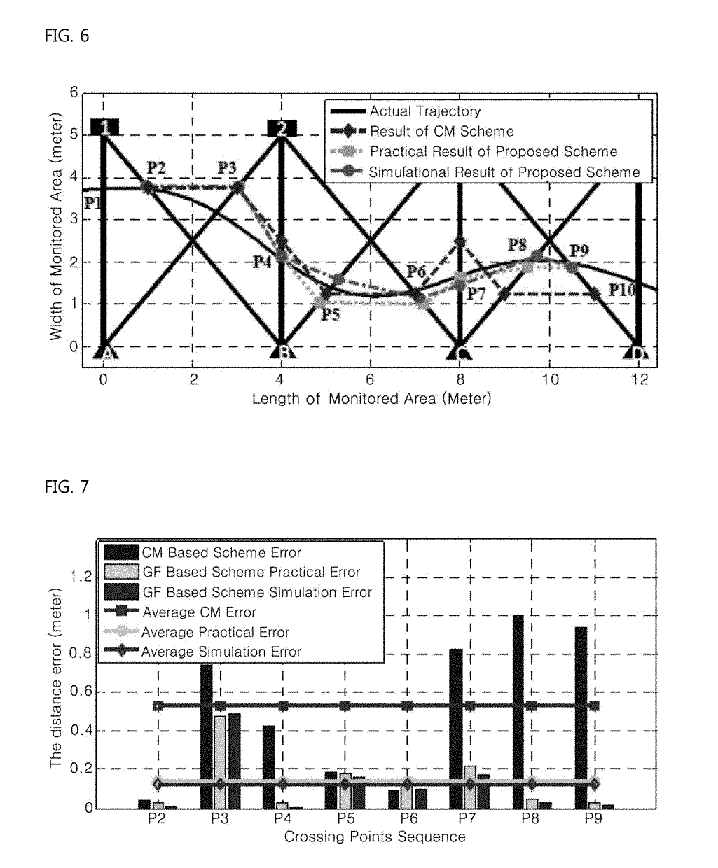

The present inventor has performed an experiment within a structure to verify an execution possibility and a performance of the conventional method CM and the geometric formulation GF. In addition, SHW-M240S is used as wireless terminals WTs (receiving module 120) to monitor an area of 5×12 m² that configures a general WLAN, and ZIO-AP1500N router is used as access points APs (transmitting module 110. Further, in an assumption that positions of the wireless terminals WTs (receiving modules 120) are obtained by an active position tracking while an error of the active position tracking is not considered in a performance of a passive position tracking, the access points APs (transmitting modules 110) and wireless terminals WTs (receiving modules 120) of third persons are fixed in identified positions. While tracking positions, the wireless terminals WTs (receiving modules 120) gather RSS values of radio signals transmitted from the access points APs (transmitting modules 110) and transmit the gathered values to a main server (controller 130). The main server records sequences and time stamps of the blocked LOSL. An AP-WT arrangement having similar LOSL density and confirmed through a widespread simulation and experiment is nearly impervious to a performance of position tracking. Therefore, a rectangular AP-WT arrangement is used for the experiment as shown in FIG. 6 to simplify a calculation and a statistic, but it is not necessary.

The present inventor evaluated a passive position track technique in which a moving object walks along a random track within a track observed area as shown in FIG. 6. In addition, the present inventor provides a computer simulation result in which a LOSL is ideally blocked by a moving object and a theoretical estimation result of a cross point estimation based on a geometric formulation GF. Logically, a theoretical simulation result shows a cross point estimation error embodied in a position tracking algorithm based on GF that is caused by zigzag tracks, which will be described later. An actual cross point CP estimation error is configured with a unique position tracking error of the GF algorithm and an error caused by an environmental noise that degrades an accuracy of a time index of the blocked LOSL.

FIG. 7 shows a performance comparison of all techniques of estimating cross points CPS after performing tens of experiments. An actual average error of the experiment based on GF technique is about 0.15 m and the GF technique is superior to a CM technique in which an error is more than about 0.5 m. Considering that the experiment was tracking a position of a device-free target within an area of 5×12 m², it is worthy of notice that the GF technique of the present invention has remarkably high accuracy compared to the CM technique In addition, the actual error and the simulation error that is about 0.12 m are about the same, and this shows a strength of the GF algorithm of the present invention about a time variation of the measured blocked time of the LOSL, wherein the time variation is caused by environmental noise. Further, errors in P3, P5, and P7 are bigger than other cross points. This is because the GF algorithm of the present invention is sensitive to an amount of meanderings within the track. Herein, two meanderings within the track are defined as a track length and a curvature between two blocked LOSL. The simulation error is derived from an approximated value of a straight track about all tracks, in other words, the error is derived from calculating an approximated value of the track with curvature using approximate straight line (ASL). The more meandering that is provided within the track, the less reliable the approximated value will be, and large errors may occur. For example, as you can imagine, if both tracks between P2 to P3, and P3 to P4 are long tracks, and a large error when estimating a position of P3 will be caused. However, estimation accuracy is improved by increasing the density of the LOSL. Because, when the density of the LOSL is higher, the segments are cut off a little shorter, thus a track-line approximate value is improved and a meandering problem of a track is relieved.

As described above, system and method of passively tracking an object moving inside a structure, according to the present invention, improves an accuracy of a position tracking (detecting) of the moving object without requiring the moving object to carry a terminal or a sensor by using a geometric formulation technique configured with a plurality of access points APs and wireless terminals WTs, measuring values changed in received signal strengths (RSS), the RSS values being changed when the LOSL is blocked by a movement of the moving object, and applying a particle swarm optimization (PSO) algorithm to the measured RSS values.

In addition, the system for passively tracking the moving object, according to the present invention, has a simple configuration and provides performance with high efficiency, thus the present invention may be applied to a normal wireless LAN and other environments.

In addition, the system for passively tracking the moving object according to the present invention is very powerful against environmental noise and provides an accuracy precision of about decimeter.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A system for passively tracking a device-free moving object inside a structure, the system comprising:
a plurality of transmitting modules installed on a surface of an inner sidewall of a structure and forming a line of sight link (LOSL) by transmitting radio signals for detecting a moving object;
a plurality of receiving modules installed on a surface of a wall that faces the wall on which the plurality of transmitting modules are installed, forming the LOSL with the transmitting modules by receiving the radio signals transmitted from the transmitting modules, and gathering values changed in received signal strengths (RSS) of the radio signals, and transmitting the gathered values to an upper layer, the RSS values being changed when the LOSL is blocked by a movement of the moving object; and
a controller electrically connected both to the plurality of transmitting modules and to the plurality of the receiving modules, checking states of the transmitting modules and the receiving modules and controlling operations of the transmitting modules and the receiving module, recording sequences and time stamps of the blocked LOSL by receiving the changed RSS values from the receiving modules, and tracking a moving path of the moving object by using cross point information based on the recorded sequences and time stamps in which the moving object crosses the LOSL.

2. The system of claim 1, wherein the controller includes a software program configured to execute a particle swarm optimization (PSO) algorithm that uses previous historical information of the moving object to detect an accurate position of a current cross point between the LOSL and the moving object.

3. The system of claim 2, wherein the previous historical information of the moving object includes at least cross point information and a time stamp of an immediately preceding LOSL(LOSL(n−1)) cross point between the LOSL and the moving object.

4. The system of claim 1, wherein the transmitting modules and the receiving modules are fixed at predetermined locations.

5. The system of claim 1, wherein the transmitting modules and the receiving modules are asymmetrically disposed with each other such that the moving path of the moving object does not become absolutely symmetrical.

6. The system of claim 1, wherein the transmitting modules are wireless routers and the receiving modules are smart phones.

7. The system of claim 1, wherein the receiving modules are positioned to be spaced apart from the wall by predetermined distances to relieve a multi-path effect of the radio signals while gathering the changed RSS values.

8. A method of passively tracking a device-free moving object inside a structure by using a passive tracking system, the system including a plurality of transmitting modules, a plurality of receiving modules, and a controller, the method comprising:
a) forming, by the plurality of transmitting modules, a line of sight link (LOSL) by transmitting radio signals for detecting the moving object;
b) forming, by the plurality of receiving modules, the line of sight link (LOSL) with the plurality of transmitting modules by receiving the radio signals transmitted from the plurality of transmitting modules;
c) gathering values changed in received signal strengths (RSS) and transmitting the gathered values to the controller by the plurality of receiving modules, the RSS values being changed when the LOSL is blocked by a movement of the moving object;
d) recording, by the controller, sequences and time stamps of the blocked LOSL by receiving the changed RSS values from the receiving modules;
e) estimating, by the controller, a cross point at which the moving object crosses the LOSL based on the recorded sequences and time stamps of the blocked LOSL; and
f) tracking, by the controller, a moving path of the moving object based on information of the estimated cross point.

9. The method of claim 8, wherein in the estimating the cross point, the controller executes a particle swarm optimization (PSO) algorithm that uses previous historical information of the moving object to estimate an accurate position of a current cross point between the LOSL and the moving object by executing a software program provided therein.

10. The method of claim 9 wherein the previous historical information of the moving object includes at least cross point information and a time stamp of an immediately preceding LOSL(LOSL(n−1)) cross point between the LOSL and the moving object.

11. The method of claim 9, wherein the PSO algorithm includes:
i) uniformly scattering particles having two elements within θ, within a limited area that is expressed in formula 1, wherein the θ and the formula 1 are as follows:
θ=[y_{cp}ⁱ,\hat{k}ⁱ] and
x_{cp}ⁱ,y_{cp}ⁱ∈[L(i)∩L(i−1)˜L(i)∩L(i+1)] [Formula 1]
ii) calculating a suitable value for each particle by using formula 5 and initially setting a best suited position P_{best} among the calculated suitable values to self-historical information, wherein the formula 5 is as follows:
fun=1/Σⱼ₌₁ⁱ⁺¹(dₜₕ^{j}−dₘ^{j})²; [Formula 5]
iii) initially setting a particle that has the best suited value among all particles to a best suited position of the all gathered values;
iv) calculating a particle speed for each particle by using formula 7 and updating a particle position by using formula 8, wherein the formulas 7 and 8 are as follows:
ν(t+1)=w·ν(t)+c₁·rand( )·(P_{best,\hat{k}}_{ⁱ}(t)−\hat{k}ⁱ(t))+c₂·rand( )·(G_{best,\hat{k}}_{ⁱ}(t)−\hat{k}ⁱ(t)) [Formula 7]
\hat{k}ⁱ(t+1)=\hat{k}ⁱ(t)+ν(t+1);and [formula 8]
v) calculating a suitable value for each particle by using the formula 5, and updating to the P_{best} if a current P_{best} is better than the P_{best} of the historical information, wherein the formula 5 is as follows:
fun=1/Σⱼ₌ᵢⁱ⁺¹(dₜₕ^{j}−dₘ^{j})²; and [Formula 5]
vi) updating to a G_{best} if a current G_{best} is better than a G_{best} of the historical information before reaching the maximum number of iteration times.

12. The method of claim 11, wherein in the updating of the particle position, the update is canceled when an updated position exceeds the limited area.
